(19) United States
(12) Patent Application Publication
(10) Pub. No.: US 2007/0149650 A1
(43) Pub. Date: Jun. 28, 2007

(54) Inorganic-organic composite functional composition

(75) Inventor: Gen Masuda, Chiba (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Nisshinbo Industries, Inc., Tokyo (JP)

(21) Appl. No.: 10/583,408

(22) PCT Filed: Dec. 17, 2004
(86) PCT No.: PCT/JP04/18894

§ 371 Date: Jun. 20, 2006

(30) Foreign Application Priority Data
Dec. 22, 2003 (JP) 2003-424845

(51) Int. Cl. C08K 9/12; C08K 3/26; C08K 3/34

(52) U.S. Cl. 523/210; 524/425; 524/442

(57) ABSTRACT

Disclosed is an inorganic-organic composite functional composition which comprises an organic resin and an inorganic matter having an organic layer which is formed in a solvent containing an ionic liquid. A formed article made of such an inorganic-organic composite functional composition can be prevented from deterioration in the physical properties even when a large amount of the inorganic matter is dispersed in the organic resin.

### TECHNICAL FIELD

The present invention relates to inorganic-organic composite functional compositions.

### BACKGROUND ART

Organic resins are fabricated into films and other shaped articles, and used in a variety of applications.

To enhance the physical properties of the fabricated articles and impart the articles with special capabilities, inorganic materials are commonly added to the organic resin as a modifier. Fabricated articles made of compositions obtained by thus adding an inorganic material to an organic resin, because they are endowed with a combination of the characteristic qualities of an inorganic material and the characteristic qualities of an organic material, are used in a broad range of applications.

However, when the inorganic material is mixed into a resin or the like serving as the base, if the inorganic material is not sufficiently dispersible, a high loading of the inorganic material in the base resin will be difficult to achieve, resulting in a less than satisfactory improvement in the target properties. It is thus critical to increase the affinity between the resin and the inorganic material, and to increase the dispersibility of the inorganic material in the base resin.

Inorganic materials generally have a poor dispersibility in resins. When there is a need to incorporate an inorganic material into a resin, the dispersibility is often increased by resorting to both mechanical dispersion, e.g., with a ball mill, and the use of a dispersant such as a surfactant or colloidal silica.

Yet, there is a limit to the degree of dispersion that can be achieved by mechanical dispersion. Moreover, in spite of the ease and convenience of a method for improving the dispersibility of the inorganic material in a base resin by the addition of a dispersant, adding the dispersant has such undesirable effects as increasing the dielectric constant and lowering the heat resistance of shaped articles fabricated from the composition.

Attempts have thus been made to enhance the dispersibility of inorganic materials in the resin by subjecting the inorganic material to surface modification treatment. One such surface modification treatment of inorganic materials in common use today involves coating the surface of the inorganic material with an organic compound.

In this method, the ability of the organic compound to adhere to the surface of the inorganic material is important. To increase such adhesion, use is made of a method in which a compound, such as a silane coupling agent, having functional groups capable of reacting with functional groups present on the surface of the inorganic material or functional groups introduced thereon by surface modification, is employed to administer a strong coating by means of chemical bonding (see Patent Document 1: JP-A 61-275359, and Patent Document 2: JP-A 63-258958).

Yet, although a strong coating can easily be formed on the surface of the inorganic material by these prior-art methods, the resulting inorganic material lacks sufficient dispersibility in solvents and organic resins.

Efforts have thus been made recently to enhance the dispersibility of the inorganic material in solvents and resins by coating the surface of the inorganic material with a polymer layer (see Patent Document 3: JP-A 57-102959, Patent Document 4: JP-A 5-295294, and Patent Document 5: JP-A 5-295052).

However, owing to the low efficiency of graft polymerization and other reasons, the surface-treated inorganic materials obtained by such methods lack a polymer layer of sufficient thickness on the surface thereof. Moreover, formation of the polymer layer on the surface fails to sufficiently suppress such characteristics inherent to the inorganic material as a high dielectric constant and a low acid resistance. As a result, while the improvement in dispersibility does enable high loadings to be achieved, new problems such as a decline in acid resistance and a rise in the dielectric constant have emerged in the shaped articles ultimately obtained.

Patent Document 1: JP-A 61-275359

Patent Document 2: JP-A 63-258958

Patent Document 3: JP-A 57-102959

Patent Document 4: JP-A 5-295294

Patent Document 5: JP-A 5-295052

### DISCLOSURE OF THE INVENTION

### Problems to be Solved by the Invention

It is therefore an object of the present invention to provide an inorganic-organic composite functional composition which includes both an organic layer-bearing inorganic material and an organic resin, and which, even at high loadings of the inorganic material, is capable of preventing a decline in the physical qualities of shaped articles made therefrom.

### Means for Solving the Problems

We have conducted extensive investigations in order to achieve the above objects. As a result, we have discovered that, in a composition obtained by mixing into an organic resin an inorganic material bearing an organic layer that was formed within an ionic liquid-containing solvent, because the inorganic material has an excellent dispersibility, high loadings of the inorganic material can be achieved without the addition of a dispersant such as a surfactant. We have also found that when this organic layer is formed by graft polymerization the thickness of the organic layer increases, making it possible to effectively suppress the decrease in acid resistance and the decline in physical qualities, such as a rise in dielectric constant, which have occurred in prior-art compositions formed by adding an inorganic material to an organic resin.

Accordingly, the present invention provides the following inorganic-organic composite functional compositions.
[1] An inorganic-organic composite functional composition which includes an organic layer-bearing inorganic material and an organic resin, wherein the organic layer is formed in an ionic liquid-containing solvent.
[2] The inorganic-organic composite functional composition of [1] above wherein the organic layer is a polymer layer.
[3] The inorganic-organic composite functional composition of [1] or [2] above wherein the polymer layer is a layer formed by graft polymerization.
[4] The inorganic-organic composite functional composition of any one of [1] to [3] above wherein the polymer layer has an average thickness of at least 5 nm.
[5] The inorganic-organic composite functional composition of any one of [1] to [4] above wherein the inorganic material is in the form of particles having an average particle size of 1 nm to 100 μm.
[6] The inorganic-organic composite functional composition of any one of [1] to [5] above wherein the inorganic material is one or more selected from the group consisting of alkaline earth metal carbonates, alkaline earth metal silicates, alkaline earth metal phosphates, alkaline earth metal sulfates, metal oxides, metal hydroxides, metal silicates and metal carbonates.

### Advantageous Effects of the Invention

Because the composition of the invention is obtained by mixing into an organic resin an inorganic material bearing an organic layer that has been formed in an ionic liquid-containing solvent, the inorganic material has an excellent dispersibility in the organic resin. This makes it possible to achieve a high loading of the inorganic material in the organic resin without adding a dispersant such as a surfactant, as a result of which declines in the heat resistance of the composition and in its physical qualities (e.g., a rise in the dielectric constant) associated with the addition of a dispersant can be avoided.

Moreover, by forming this organic layer by graft polymerization, the thickness of the organic layer increases, making it possible to effectively inhibit the decrease in acid resistance and the decline in physical qualities (e.g., rise in dielectric constant) which have arisen in the prior art when a large amount of inorganic material is added to an organic resin.

Furthermore, because an ionic liquid is used in surface treatment of the inorganic material, the production time can be shortened, the amount of organic solvent used can be held to zero or a very small amount, and the ionic liquid can be reused, thus providing excellent environmental compatibility and safety.

### BEST MODE FOR CARRYING OUT THE INVENTION

The invention is described more fully below.

Inorganic-organic composite functional compositions according to the invention include an organic layer-bearing inorganic material and an organic resin. The organic layer is formed in an ionic liquid-containing solvent.

Illustrative, non-limiting examples of the inorganic material in the invention include alkaline earth metal carbonates such as calcium carbonate, barium carbonate and magnesium carbonate; alkaline earth metal silicates such as calcium silicate, barium silicate and magnesium silicate; alkaline earth metal phosphates such as calcium phosphate, barium phosphate and magnesium phosphate; alkaline earth metal sulfates such as calcium sulfate, barium sulfate and magnesium sulfate; metal oxides such as silica, aluminum oxide, zinc oxide, iron oxide, titanium oxide, cobalt oxide, nickel oxide, manganese oxide, antimony oxide and tin oxide; metal hydroxides such as iron hydroxide, nickel hydroxide, aluminum hydroxide, calcium hydroxide and chromium hydroxide; metal silicates such as zinc silicate, aluminum silicate and copper silicate; and metal carbonates such as zinc carbonate, aluminum carbonate, cobalt carbonate, nickel carbonate and basic copper carbonate. These may be used singly or as combinations of two or more thereof.

Of these, to impart shaped articles made from the inventive composition with a functionality suitable for electronic materials, it is preferable to use an inorganic oxide or hydroxide such as silica, magnesium hydroxide, aluminum hydroxide or calcium hydroxide. The use of an inorganic hydroxide such as magnesium hydroxide, aluminum hydroxide or calcium hydroxide is even more preferred.

The shape of the inorganic material will vary according to the intended use of the composition and therefore cannot be strictly specified. However, given that improvement in the dispersibility of the inorganic material within the composition and improvements in the formability and flame retardance are proportional to the specific surface area of the inorganic material (see Kobunshi no nannen-ka gijutsu [Polymer flame-retarding technology], published by CMC Shuppan), it is desirable for the inorganic material to be in the form of spherical or substantially spherical particles having an average size of 1 nm to 100 μm, preferably 10 nm to 50 μm, and more preferably 30 nm to 30 μm.

The average particle size is measured with a particle size analyzer (9320-X100, manufactured by Nikkiso Co., Ltd.).

The organic layer in the invention is not subject to any particular limitation, provided it is a layer made of an organic compound. For example, the organic layer may be a layer composed of a low-molecular-weight organic compound or a layer made of a high-molecular-weight organic compound (polymer layer), although a polymer layer is preferred. By using a polymer layer, the organic layer can be imparted with a sufficient thickness, thus making it possible to effectively prevent the decline in physical qualities that typically occurs when a composition is formed by mixing an organic layer-bearing inorganic material into an organic resin.

When forming the organic layer on the surface of the inorganic material, although the organic layer can be formed based on functional groups on the inorganic material itself, it is preferable to first modify the surface of the inorganic material with reactive functional groups.

The reactive functional groups may be selected as appropriate for the organic layer forming method. Illustrative examples include groups having polymerizable unsaturated bonds, such as α,β-unsaturated carbonyl groups, α,β-unsaturated nitrile groups, halogenated vinyl groups, halogenated vinylidene groups, aromatic vinyl groups, heterocyclic vinyl groups, conjugated dienes, and vinyl carboxylates; and also carboxyl groups, carbonyl groups, epoxy groups, isocyanate groups, hydroxyl groups, amide groups, cyano groups, amino groups, epoxy groups, chloromethyl groups, glycidyl ether groups, lithio groups, ester groups, formyl groups, nitrile groups, nitro groups, carbodiimide groups and oxazoline groups.

Various known methods may be employed for modifying the inorganic material with these reactive functional groups, although a method involving treatment of the inorganic material with a surface treatment agent selected according to the functional group to be introduced onto the inorganic material is simple and thus preferable.

Illustrative, non-limiting examples of surface treatment agents include unsaturated fatty acids such as oleic acid; unsaturated fatty acid metal salts such as sodium oleate, calcium oleate and potassium oleate; unsaturated fatty acid esters; unsaturated fatty acid ethers; surfactants; silane coupling agents such as methacryloxymethyltrimethoxysilane, methacryloxypropyltrimethoxysilane, n-octadecylmethyldiethoxysilane, dodecyltrimethoxysilane, 2-(3,4-epoxycyclohexyl)ethyltrimethoxysilane, 2-(4-chlorosulfonyl)ethyltrimethoxysilane, triethoxysilane, vinyltrimethoxysilane and phenethyltrimethoxysilane; and titanate coupling agents.

If the organic layer is made of a low-molecular-weight compound, the above-mentioned surface treatment agent may also serve as that low-molecular-weight organic compound, although use can also be made of organic compounds such as the following: saturated fatty acids such as stearic acid; fatty acid metal salts such as sodium stearate, calcium stearate, and potassium stearate; fatty acid esters; fatty acid ethers; styrene compounds such as styrene, o-methylstyrene, m-methylstyrene, p-methylstyrene, α-methylstyrene, p-ethylstyrene, 2,4-dimethylstyrene, p-n-butylstyrene, p-t-butylstyrene, p-n-hexylstyrene, p-n-octylstyrene, p-n-nonylstyrene, p-n-decylstyrene, p-n-dodecylstyrene, p-methoxystyrene, p-phenylstyrene, p-chlorostyrene and 3,4-dichlorostyrene; acrylic acid, methacrylic acid and (meth)acrylic acid derivatives such as methyl acrylate, ethyl acrylate, n-butyl acrylate, isobutyl acrylate, propyl acrylate, hexyl acrylate, 2-ethylhexyl acrylate, n-octyl acrylate, dodecyl acrylate, lauryl acrylate, stearyl acrylate, 2-chloroethyl acrylate, phenyl acrylate, methyl α-chloroacrylate, methyl methacrylate, ethyl methacrylate, n-butyl methacrylate, isobutyl methacrylate, propyl methacrylate, hexyl methacrylate, 2-ethylhexyl methacrylate, n-octyl methacrylate, dodecyl methacrylate, lauryl methacrylate, stearyl methacrylate, (meth)acrylate and methyl (meth)acrylate; carboxylic acids and carboxylic acid derivatives such as vinyl acetate, vinyl propionate, vinyl benzoate, vinyl butyrate, formic acid, acetic acid, propionic acid, butyric acid, valeric acid, oxalic acid, malonic acid, succinic acid, glutaric acid, adipic acid, pimelic acid, maleic acid, fumaric acid, phthalic acid, isophthalic acid, terephthalic acid, acetyl chloride and benzoyl chloride; vinyl ethers such as vinyl methyl ether, vinyl ethyl ether and vinyl isobutyl ether; vinyl ketones such as vinyl methyl ketone, vinyl hexyl ketone and methyl isopropenyl ketone; N-vinyl compounds such as N-vinylpyrrole, N-vinylcarbazole, N-vinylindole and N-vinylpyrrolidone; compounds having fluoroalkyl groups, such as vinyl fluoride, vinylidene fluoride, tetrafluoroethylene, hexafluoropropylene, trifluoroethyl acrylate and tetrafluoropropyl acrylate; alcohols such as methanol, ethanol, phenol, methylphenol, nitrophenol, picric acid, ethylene glycol and glycerol; halogenated compounds such as ethyl bromide, (S)-3-bromo-3-methylhexane and chloromethane; amine compounds such as ethylamine, aminoethane, 2-aminopeptane, 3-aminobutanoic acid, aniline, p-bromoaniline, cyclohexylamine, ammonia, acetamide, p-toluidine and p-nitrotoluene; formaldehyde; and (meth)acrylonitrile. These may be used singly or as combinations of two or more thereof.

These low-molecular-weight organic compounds may be bonded by means of, for example, covalent bonds, hydrogen bonds or coordinate bonds to functional groups present on the inorganic material itself, or to the above-described reactive functional groups that have been introduced onto the inorganic material, so as to form the organic layer. The reaction between the inorganic material and the low-molecular-weight organic compound may be selected from among suitable known techniques in accordance with the type of bond.

If the organic layer is a polymer layer, illustrative, non-limiting, examples of the polymer making up the layer include olefin polymers such as polyethylene and polypropylene; poly(meth)acrylic acid derivatives such as polymethyl methacrylate and polyethyl methacrylate; vinyl carboxylates such as polyvinyl acetate, polyvinyl propionate, polyvinyl benzoate and polyvinyl butyrate; polyvinyl ethers such as polyvinyl methyl ether, polyvinyl ethyl ether and polyvinyl isobutyl ether; polyvinyl ketones such as polyvinyl methyl ketone, polyvinyl hexyl ketone and polymethyl isopropenyl ketone; poly(N-vinyl compounds) such as poly(N-vinylpyrrole), poly(N-vinylcarbazole), poly(N-vinylindole) and poly(N-vinylpyrrolidone); polyacrylonitrile; and polymethacrylonitrile. These may be used singly or as combinations of two or more thereof. Use can also be made of a copolymer or polymer of one or more of the above-mentioned low-molecular-weight organic compounds. Of the above, the use of polystyrene or a poly(meth)acrylic acid derivative is preferred on account of the ease of polymerizing the monomer.

It is also possible to use in the invention a polymer which forms a crosslinked structure at the surface of the inorganic material.

The polymer layer on the inorganic material has an average thickness of preferably at least 3 nm. At a polymer layer thickness of less than 3 nm, dispersibility in the organic resin may decrease, which may in turn reduce the loading of the inorganic material in the organic resin. In addition, the acid resistance and the elastic modulus of the composition may decrease, and a decline in the physical qualities, such as a rise in the dielectric constant, may occur.

In view of the above, the average thickness of the polymer layer is preferably at least 5 nm, more preferably at least 7 nm, even more preferably at least 10 nm, and most preferably at least 15 nm.

The thickness of the polymer layer is a value calculated from the volume of the grafted polymer layer, the volume of the inorganic material and the total surface area per cubic centimeter (cm³) of the polymer grafted inorganic material, all of which were determined based on density measurements taken with a gas pycnometer (Accupyc 1330, manufactured by Shimadzu Corporation; in helium).

The polymer making up the polymer layer has a number-average molecular weight (Mn) which varies according to the grafting density, and cannot be strictly specified. Nevertheless, the number-average molecular weight is generally from 1,000 to 5,000,000, preferably from 2,500 to 4,500,000, more preferably from 5,000 to 3,000,000, and even more preferably from 10,000 to 1,000,000. The number-average molecular weight is a measured value obtained by gel filtration chromatography.

Illustrative, non-limiting, methods of coating the surface of the inorganic material with a polymer layer that may be used in the practice of the invention include a method involving the use of a spray dryer, seed polymerization, adsorption of the polymer onto the inorganic material, and a graft polymerization process that chemically bonds the polymer to the particles. Of these, the use of graft polymerization is preferred for the following reasons: (1) a polymer layer can be formed which is relatively thick and does not readily dissolve out into the surrounding solvent even when the polymer layer-bearing inorganic material is dispersed in a solvent for a long time, (2) various different surface properties can be imparted by changing the type of monomer, and (3) grafting at a high density is possible by carrying out polymerization based on polymerization initiating groups introduced onto the surface of the inorganic material.

The process of forming a polymer layer with grafted chains is exemplified here by a method in which the grafted chains are prepared beforehand by polymerization, then are chemically bonded to the surface of the inorganic material, and a method in which graft polymerization is carried out on the surface of the inorganic material. Although either method may be used, the latter approach, which is less subject to adverse effects such as steric hindrance, is preferable for increasing the density of the grafted chains at the surface of the inorganic material.

Illustrative examples of the chemical bonds between the inorganic material and the grafted chains include covalent bonds, hydrogen bonds, and coordinate bonds.

Examples of graft polymerization reactions include addition polymerization reactions such as free-radical polymerization, ionic polymerization, oxidative anionic polymerization and ring-opening polymerization; polycondensation reactions such as elimination polymerization, dehydrogenation polymerization, and denitrogenation polymerization; hydrogen transfer polymerization reactions such as addition polymerization, isomerization polymerization, and group transfer polymerization; and addition condensation. Of these, free-radical polymerization is especially preferred because it is simple, very cost-effective, and is commonly used for the industrial synthesis of various polymers. Where there is a need to control the molecular weight of the grafted chains, the molecular weight distribution and the grafting density, use can be made of living radical polymerization.

Living radical polymerization is broadly divided into three types, any of which may be used in the present invention: (i) a dissociation-bonding mechanism in which polymerization proceeds by activation involving the use of typically heat or light to reversibly cleave the covalent bond on a dormant species P-X so that it dissociates to a P radical and an X radical; (ii) an atom transfer mechanism (atom transfer radical polymerization, or ATRP) in which polymerization proceeds by the activation of P-X under the action of a transition metal complex; and (iii) an exchange chain transfer mechanism in which polymerization proceeds by P-X triggering an exchange reaction with another radical.

The graft polymerizable monomers are not subject to any particular limitation, provided they are compounds having functional groups capable of reacting in graft polymerization.

For example, when a radical polymerization reaction is employed, use can be made of any one or combination of two or more of the following reactive unsaturated bond (double bond)-bearing monomers: styrene compounds such as styrene, o-methylstyrene, m-methylstyrene, p-methylstyrene, α-methylstyrene, p-ethylstyrene, 2,4-dimethylstyrene, p-n-butylstyrene, p-t-butylstyrene, p-n-hexylstyrene, p-n-octylstyrene, p-n-nonylstyrene, p-n-decylstyrene, p-n-dodecylstyrene, p-methoxystyrene, p-phenylstyrene, p-chlorostyrene and 3,4-dichlorostyrene; (meth)acrylic acid derivatives such as methyl acrylate, ethyl acrylate, n-butyl acrylate, isobutyl acrylate, propyl acrylate, hexyl acrylate, 2-ethylhexyl acrylate, n-octyl acrylate, dodecyl acrylate, lauryl acrylate, stearyl acrylate, 2-chloroethyl acrylate, phenyl acrylate, methyl a-chloroacrylate, methyl methacrylate, ethyl methacrylate, n-butyl methacrylate, isobutyl methacrylate, propyl methacrylate, hexyl methacrylate, 2-ethylhexyl methacrylate, n-octyl methacrylate, dodecyl methacrylate, lauryl methacrylate and stearyl methacrylate; vinyl carboxylates such as vinyl acetate, vinyl propionate, vinyl benzoate and vinyl butyrate; vinyl ethers such as vinyl methyl ether, vinyl ethyl ether and vinyl isobutyl ether; vinyl ketones such as vinyl methyl ketone, vinyl hexyl ketone and methyl isopropenyl ketone; N-vinyl compounds such as N-vinylpyrrole, N-vinylcarbazole, N-vinylindole and N-vinylpyrrolidone; compounds having fluoroalkyl groups, such as vinyl fluoride, vinylidene fluoride, tetrafluoroethylene, hexafluoropropylene, trifluoroethyl acrylate and tetrafluoropropyl acrylate; and acrylonitrile and methacrylonitrile. Of these, from the standpoint of monomer reactivity, the use of a vinyl group-based and/or (meth)acryl group-based monomer, copolymer or polymer is preferred.

When radical polymerization is employed, it is also possible to prepare a polymer having a crosslinked structure using a monomer with two or more reactive unsaturated bonds (double bonds). Illustrative, non-limiting, examples of such monomers include aromatic divinyl compounds such as divinylbenzene and divinylnaphthalene; and compounds such as ethylene glycol diacrylate, ethylene glycol dimethacrylate, triethylene glycol dimethacrylate, tetraethylene glycol dimethacrylate, 1,3-butylene glycol dimethacrylate, trimethylolpropane triacrylate, trimethylolpropane trimethacrylate, 1,4-butanediol diacrylate, neopentyl glycol diacrylate, 1,6-hexanediol diacrylate, pentaerythritol triacrylate, pentaerythritol tetraacrylate, pentaerythritol dimethacrylate, pentaerythritol tetramethacrylate, glycerol acryloxy dimethacrylate, N,N-divinyl aniline, divinyl ether, divinyl sulfide and divinyl sulfone. These may be used singly or as combinations of two or more thereof. Of the above, the use of a vinyl group-based and/or a (meth)acryl group-based monomer or copolymer is preferred.

Any of various known polymerization initiators may be used when carrying out radical polymerization. Illustrative examples include benzoyl peroxide, cumene hydroperoxide, t-butyl hydroperoxide, persulfates such as sodium persulfate, potassium persulfate and ammonium persulfate, and azo compounds such as azobisisobutyronitrile, azobismethylbutyronitrile and azobisisovaleronitrile. These may be used singly or as combinations of any two or more thereof.

When a polymerization process other than free radical polymerization is employed, illustrative, non-limiting, examples of compounds which may be reacted with the reactive functional groups that have been introduced onto the surface of the inorganic material include carboxylic acids and carboxylic acid derivatives, such as formic acid, acetic acid, propionic acid, butyric acid, valeric acid, oxalic acid, malonic acid, succinic acid, glutaric acid, adipic acid, pimelic acid, maleic acid, fumaric acid, phthalic acid, isophthalic acid, terephthalic acid, acetyl chloride and benzoyl chloride; inorganic acids and inorganic bases such as sulfuric acid, phosphoric acid, sodium hydroxide and potassium hydroxide; alcohols such as methanol, ethanol, phenol, methylphenol, nitrophenol, picric acid, ethylene glycol and glycerol; halogenated organic compounds such as ethyl bromide, (S)-3-bromo-3-methylhexane and chloromethane; amine compounds such as ethylamine, aminoethane, 2-aminopentane, 3-aminobutanoic acid, aniline, p-bromoaniline, cyclohexylamine, ammonia, acetamide, p-toluidine and p-nitrotoluene; and formaldehyde. Use may also be made of copolymers or polymers composed of one or more of these compounds.

The graft polymerization conditions are not subject to any particular limitation. Various known conditions may be employed according to such considerations as the monomer being used.

For example, when grafting is effected by carrying out free radical polymerization at the surface of the inorganic material, the amount of monomer having functional groups that can be reacted per 0.1 mol of reactive functional groups introduced onto the inorganic material is from 1 to 300 mol, and the amount of polymerization initiator is generally from 0.005 to 30 mol. The polymerization temperature is generally from −20 to 1,000° C., and the polymerization time is generally from 0.2 to 72 hours.

When graft polymerization is carried out, various additives such as dispersants, stabilizers and emulsifying agents (surfactants) may be optionally added to the polymerization reaction system.

The polymer layer formed by graft polymerization, aside from being obtained by grafting at the surface of the inorganic material in the manner just described, may alternatively be obtained, as noted above, by reacting an already prepared polymer with reactive functional groups on the surface of the inorganic material.

Illustrative examples of methods that may be used to react the inorganic hydroxide with the polymer in such a case include a dehydration reaction, a nucleophilic substitution reaction, an electrophilic substitution reaction, an electrophilic addition reaction, and an adsorption reaction.

In the practice of the invention, the above-described organic layer is formed within an ionic liquid. The method used is either a method involving the reaction, within the ionic liquid, of the inorganic material with the low-molecular-weight or high-molecular-weight organic compound from which the organic layer is made, or a method in which the polymerization reaction at the surface of the inorganic material is carried out in an ionic liquid. “Ionic liquid” is used herein as a generic term for liquid salts, particularly salts which are liquid near room temperature. An ionic liquid is a solvent composed entirely of ions.

The ionic liquid in the present invention is not subject to any particular limitation, although it is preferable for the cation in the ionic liquid to be at least one selected from among ammonium cations, imidazolium cations and pyridinium cations. Of these, ammonium cations are especially preferred.

Imidazolium cations, while not subject to any particular limitation, are exemplified by dialkylimidazolium cations and trialkylimidazolium cations. Specific examples include the 1-ethyl-3-methylimidazolium ion, the 1-butyl-3-methylimidazolium ion, the 1,2,3-trimethylimidazolium ion, the 1,2-dimethyl-3-ethylimidazolium ion, the 1,2-dimethyl-3-propylimidazolium ion, and the 1-butyl-2,3-dimethylimidazolium ion.

Pyridinium cations, while not subject to any particular limitation, are exemplified by the N-propylpyridinium ion, the N-butylpyridinium ion, the 1-butyl-4-methylpyridinium ion and the 1-butyl-2,4-dimethylpyridinium ion.

Ammonium cations, while not subject to any particular limitation, are exemplified by aliphatic or alicyclic quaternary ammonium ions as the cation component.

Illustrative, non-limiting, examples of these aliphatic or alicyclic quaternary ammonium ions include such quaternary alkyl ammonium ions as the trimethylpropylammonium ion, the trimethylhexylammonium ion and the tetrapentylammonium ion; and the N-butyl-N-methylpyrrolidinium ion. The use of an aliphatic or alicyclic quaternary ammonium ion having the following general formula (1) is especially preferred. 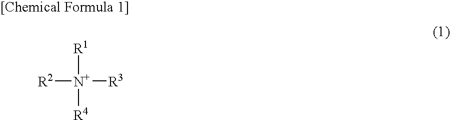
In the formula, R¹ to R⁴ are each independently an alkyl group of 1 to 5 carbons or an alkoxyalkyl group of the formula R′—O—(CH₂)ₙ— (R′ being methyl or ethyl, and the letter n being an integer from 1 to 4), and any two from among R¹, R², R³ and R⁴ may together form a ring. At least one of R¹ to R⁴ must be an alkoxyalkyl group of the above description.

In formula (1), examples of the alkyl group of 1 to 5 carbons include methyl, ethyl, propyl, 2-propyl, butyl and pentyl. The viscosity of the ionic liquid tends to increase at a higher molecular weight. Because use as a solvent becomes more difficult at a higher viscosity, it is preferable for at least one of R¹ to R⁴ to be methyl, ethyl or propyl, and especially methyl or ethyl.

Examples of the alkoxyalkyl group of the formula R′—O—(CH₂)ₙ— include methoxymethyl, ethoxymethyl, methoxyethyl, ethoxyethyl, methoxypropyl, ethoxypropyl, methoxybutyl and ethoxybutyl. As noted above, the letter n is an integer from 1 to 4. However, for a high ionic liquid-forming ability, n is preferably 1 or 2, and most preferably 2.

Exemplary cations in which any two of R¹ to R⁴ form a ring include quaternary ammonium ions having an aziridine ring, an azetidine ring, a pyrrolidine ring or a piperidine ring.

Of the quaternary ammonium ions represented by above formula (1), for reasons having to do with the high ionic liquid-forming ability, the low cost of the starting materials, and the ability of the ionic liquid to be synthesized by a relatively simple method, quaternary ammonium ions having an alkoxyethyl group of formula (2) below are preferred, and quaternary ammonium ions of formula (3) below are even more preferred. 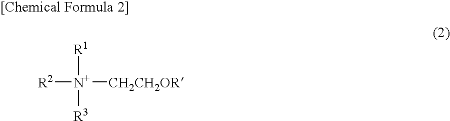
In formula (2), R¹ to R³ and R′ are the same as above. 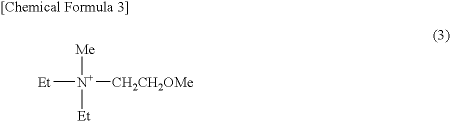
In formula (3), “Me” stands for methyl, and “Et” stands for ethyl.

Like the quaternary ammonium ions of above formula (3), ammonium cations having a 2-alkoxyethyl group readily exhibit the properties of an ionic liquid. For example, the ammonium cations of formulas (4) to (6) below exhibit the properties of an ionic liquid. These too are advantageous for use.

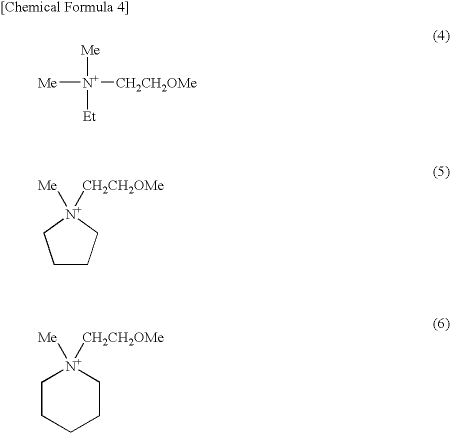

Illustrative, non-limiting, examples of the above-described anions making up the ionic liquid include BF₄⁻, PF₆⁻, AsF₆⁻, SbF₆⁻, AlCl₄⁻, HSO₄⁻, ClO₄⁻, CH₃SO₃⁻, CF₃SO₃⁻, CF₃CO₂⁻, (CF₃SO₂)₂N⁻, Cl⁻, Br⁻ and I⁻.

In the practice of the invention, the ionic liquid may be used alone, or may be used in admixture with any of various solvents that have hitherto been used.

When the ionic liquid is used in admixture with such a conventional solvent, at a content of the ionic liquid within the mixed solvent of about 5 wt %, for example, the reactivity between the reactive functional groups on the inorganic material and the functional groups on the compound which reacts therewith increases. Also, in a polymerization reaction, the molecular weight and molecular weight distribution of the grafted chains or blocked chains on the resulting polymer are easier to control. However, for such reasons as the ease of post-treatment, environmental compatibility and safety, it is preferable for the concentration of the ionic liquid in the mixed solvent to be at least 10 wt %, more preferably at least 50 wt %, and most preferably from 80 to 100 wt %.

Illustrative, non-limiting examples of solvents that may thus be used in admixture with the ionic solvent include water; alcohols such as methanol, ethanol, 1-propanol, 2-propanol, 1-butanol, 2-butanol, i-butyl alcohol, t-butyl alcohol, 1-pentanol, 2-pentanol, 3-pentanol, 2-methyl-1-butanol, i-pentyl alcohol, t-pentyl alcohol, 1-hexanol, 2-methyl-1-pentanol, 4-methyl-2-pentanol, 2-ethylbutanol, 1-heptanol, 2-heptanol, 3-heptanol, 2-octanol, 2-ethyl-1-hexanol, benzyl alcohol and cyclohexanol; ether alcohols such as methyl cellosolve, ethyl cellosolve, isopropyl cellosolve, butyl cellosolve and diethylene glycol monobutyl ether; ketones such as acetone, methyl ethyl ketone, methyl isobutyl ketone and cyclohexanone; esters such as ethyl acetate, butyl acetate, ethyl propionate and cellosolve acetate; aliphatic or aromatic hydrocarbons such as pentane, 2-methylbutane, heptane, n-hexane, 2-methylpentane, 2,2-dimethylbutane, 2,3-dimethylbutane, heptane, n-octane, isooctane, 2,2,3-trimethylpentane, nonane, decane, cyclopentane, methyl cyclopentane, cyclohexane, methyl cyclohexane, ethyl cyclohexane, p-menthane, dicyclohexyl, benzene, toluene, xylene, ethyl benzene and anisole (methoxybenzene); halogenated hydrocarbons such as carbon tetrachloride, trichloroethylene, chlorobenzene and tetrabromoethane; ethers such as diethyl ether, dimethyl ether, trioxane and tetrahydrofuran; acetals such as methylal and diethylacetal; aliphatic acids such as formic acid, acetic acid and propionic acid; and sulfur or nitrogen-bearing organic compounds such as nitropropane, nitrobenzene, dimethylamine, monoethanolamine, pyridine, dimethylformamide, dimethylsulfoxide and acetonitrile. Any one or combinations of two or more thereof may be used.

Illustrative, non-limiting, examples of the organic resin in the inorganic-organic functional composition of the invention include thermoplastic resins such as polyolefin resins (e.g., polyethylene, polypropylene), polystyrene resins (e.g., polystyrene), polyvinyl halide derivative resins (e.g., polyvinyl chloride, polyvinylidene chloride), polyvinyl acetate derivative resins (e.g., polyvinyl acetate), poly(meth)acrylic resins (e.g., polymethyl methacrylate), polyvinyl ethers (e.g., polyvinyl methyl ether, polyvinyl ethyl ether, polyvinyl isobutyl ether), polyvinyl ketones (e.g., polyvinyl methyl ketone, polyvinyl hexyl ketone, polymethyl isopropenyl ketone), poly(N-vinyl compounds) (e.g., poly(N-vinylpyrrole), poly(N-vinylcarbazole), poly(N-vinylindole), poly(N-vinylpyrrolidone)), fluoropolymers, polyamides (e.g., nylon 6), polyesters, polycarbonate, silicone, polyacetal, and acetyl cellulose; and thermoset resins such as epoxy resins, phenol resins, urea resins, melamine resins, alkyd resins, and unsaturated polyester resins.

Of these, from the standpoint of such considerations as environmental compatibility and the diversity of uses for the composition, it is preferable to use polystyrene resins, polyolefin resins, poly(meth)acrylic resins, vinyl carboxylate resins such as polyvinyl acetate, and epoxy resins.

In addition, to increase the dispersibility in and affinity to the organic resin by the inorganic material and to suppress a decline in the mechanical strength of shaped articles fabricated from compositions containing these components, it is preferable for the organic layer at the surface of the inorganic material to be the same type of compound as the organic resin. The combination of the organic layer and the organic resin is preferably a combination of a polymer layer with an organic resin, each being selected from among, for example, polystyrene resins, polyolefin resins, poly(meth)acrylic resins, vinyl carboxylate resins such as polyvinyl acetate, and epoxy resins.

No particular limitation is imposed on the compounding ratio between the organic layer-bearing inorganic material and the organic resin. However, to achieve a good balance between the various functionality-enhancing effects and the decrease in physical properties owing to incorporation of the inorganic material, the weight ratio of the organic layer-bearing inorganic material (untreated inorganic material basis) to the organic resin is preferably from 5:95 to 90:10, more preferably from 10:90 to 80:20, and even more preferably from 30:70 to 70:30.

In addition, it is preferable for the inorganic-organic composite functional composition of the invention to have at least one of characteristics (1) to (3) below. In (1) to (3) below, the organic resin in both compositions is of course the same. Also, the term ‘composition’ as used in the present invention, encompasses not only compositions of indefinite shape obtained by merely mixing the inorganic material and the organic resin, but also shaped materials obtained by shaping such compositions.
(1) The inorganic-organic composite functional composition has a percent weight loss, when acid-treated by 5 minutes of immersion in an aqueous solution containing 20 wt % of hydrogen chloride, which satisfies the following relationship with respect to the percent weight loss, when similarly acid treated, by an untreated inorganic material-containing composition that includes, instead of the polymer layer-bearing inorganic material in the inorganic-organic composite functional composition, a like amount (inorganic material basis) of an inorganic material lacking a polymer layer: (percent weight loss of inorganic-organic composite functional composition)/(percent weight loss of untreated inorganic material-containing composition) <0.5, preferably <0.4, and more preferably <0.3.

If this percent weight loss ratio is 0.50 or more, the inorganic-organic composite functional composition is very likely to have a poor acid resistance, which may make it impossible to use the composition in electrical materials that require acid treatment, or may otherwise limit its applications.

Aside from the size of the test specimen, the hydrochloric acid concentration and the duration of the test, the above test method is carried out in accordance with the test method described in JIS K7114. The percent weight loss is determined based on the weight of the composition following acid treatment, thorough washing with water, and drying.
(2) The inorganic-organic composite functional composition has a dielectric constant which satisfies the following relationship with respect to the dielectric constant of an untreated inorganic material-containing composition that includes, instead of the polymer layer-bearing inorganic material in the inorganic-organic composite functional composition, a like amount (inorganic material basis) of an inorganic material lacking a polymer layer: (dielectric constant of inorganic-organic composite functional composition)/(dielectric constant of untreated inorganic material-containing composition) <1.00, preferably <0.99, and more preferably <0.98.

If this dielectric constant ratio is 1.00 or more, the polymer layer formed on the surface of the inorganic material will have an inadequate dielectric constant increase-preventing effect, which may limit use of the composition in the same way as mentioned above.

The dielectric constant is measured at a frequency of 1 GHz using a dielectric constant measuring instrument (4291B Impedance Material Analyzer, manufactured by Agilent Technologies).
(3) The inorganic-organic composite functional composition has an elastic modulus which satisfies the following relationship with respect to the elastic modulus of an untreated inorganic material-containing composition that includes, instead of the polymer layer-bearing inorganic material in the inorganic-organic composite functional composition, a like amount (inorganic material basis) of an inorganic material lacking a polymer layer: (elastic modulus of inorganic-organic composite functional composition)/(elastic modulus of untreated inorganic material-containing composition) >1.10, preferably >1.15, and more preferably >1.20.

An elastic modulus ratio of 1.10 or less, presumably as a result of insufficient dispersibility of the inorganic material in the organic resin, may weaken the mechanical strength of a shaped material obtained by shaping the composition, and most likely will limit the uses of the composition.

The elastic modulus is measured at room temperature using a thermal analysis/rheology system (EXTAR 600, manufactured by Seiko Instrument).

The inorganic-organic composite functional compositions of the invention are able to suppress the declines in physical qualities (electrical characteristics (increased dielectric constant), mechanical characteristics (reduced elastic modulus)) and the decline in acid resistance associated with prior-art inorganic-organic composite type compositions. Moreover, because of the high affinity between the polymer layer-bearing inorganic material and the organic resin, uniform loading of the inorganic material in the organic resin can be achieved without the addition of a surfactant or other dispersant. As a result, high loadings of the inorganic material are possible, and new functionalities representing a combination of the distinctive characteristics of the inorganic material and the distinctive characteristics of the organic material can be effectively achieved.

This inorganic-organic composite functional composition also varies according to the type of inorganic material, polymer layer and organic resin, and is not subject to any particular limitation. For example, it can be advantageously used as materials requiring various types of functionality in such areas as electronics materials, building materials, and automotive materials.

### EXAMPLES

The invention is illustrated more fully through the following synthesis examples, examples of the invention, and comparative examples. It should be noted, however, that the examples of the invention provided below are not intended to limit the invention.

### Synthesis Example 1

### Synthesis of Bis(trifluoromethanesulfonimide) Salt of Diethylmethyl(2-methoxyethyl)ammonium (Abbreviated Below as “DEME.TFSI”)

[Synthesis of Ionic Liquid]

A solution was prepared by mixing together 100 mL of diethylamine (available from Kanto Chemical Co., Ltd.) and 85 mL of 2-methoxyethyl chloride (Kanto Chemical), following which the solution was placed in an autoclave and reacted at 100° C. for 24 hours. The pressure within the autoclave at this time was 0.127 MPa (1.3 kgf/cm²). After 24 hours, 200 ml of an aqueous solution containing 56 g of dissolved potassium hydroxide (Katayama Chemical, Inc.) was added to the resulting mixture of precipitated crystals and reaction solution, and the organic phase that divided into two was separated off with a separatory funnel. Next, 100 mL of methylene chloride (Wako Pure Chemical Industries, Ltd.) was added and extraction carried out two times.

The organic phase that had been separated off was combined, then washed with saturated saline, following which it was dried over potassium carbonate (Wako Pure Chemical Industries) and vacuum filtered. The solvent was driven from the organic phase with a rotary evaporator, following which the residue was subjected to atmospheric pressure distillation, yielding a fraction which boiled at close to 135° C. This compound was confirmed by ¹H-NMR spectroscopy to be 2-methoxyethyldiethylamine.

Next, 8.24 g of the 2-methoxyethyldiethylamine was dissolved in 10 mL of tetrahydrofuran (Wako Pure Chemical Industries), then 4.0 mL of methyl iodide (Wako Pure Chemical Industries) was added under ice cooling. After 30 minutes, the ice bath was removed and the mixture was stirred overnight at room temperature. The solvent in this reaction mixture was removed by vacuum distillation, and the resulting solids were recrystallized from an ethanol (Wako Pure Chemical Industries) - tetrahydrofuran system, giving 16 g of 2-methoxyethyldiethylmethylammonium iodide.

Next, 10.0 g of the 2-methoxyethyldiethylmethylammonium iodide was dissolved in 50 mL of acetonitrile (Kanto Chemical). Lithium bis(trifluoromethanesulfonyl)imide, 9.5 g, (Kishida Chemical Co., Ltd.) was then added to the solution and completely dissolved therein, after which the system was stirred for 15 minutes.

The acetonitrile was subsequently removed by vacuum distillation, and water was added to the residue. The organic phase that divided in two was separated off, then washed five times with water to remove impurities.

After washing, the washed organic phase was placed under a reduced pressure using a vacuum pump and the water was thoroughly driven off, yielding 6.8 g of the title ionic liquid which was liquid at room temperature.

### Synthesis Example 2

### Synthesis of Tetrafluoroborate Salt of Diethylmethyl(2-methoxyethyl)ammonium (Abbreviated Below as “DEME-BF₄”)

First, 15.0 g of 2-methoxyethyldiethylmethyl ammonium iodide synthesized in the same way as in Synthesis Example 1 was dissolved in 100 mL of distilled water, after which 6.37 g of silver oxide (Kanto Chemical) was added and the mixture was stirred for 3 hours. This reaction mixture was vacuum filtered to remove precipitates, following which 42% tetrafluoroboric acid (Kanto Chemical) was added a little at a time under stirring until the reaction solution reached a pH of about 5 to 6. This reaction solution was then freeze-dried and water was thoroughly driven off with a vacuum pump, yielding 12.39 g of the title ionic liquid which was liquid at room temperature.

### Synthesis Example 3

### Synthesis of Bis(trifluoromethanesulfonylimide) Salt of N-(2-methoxyethyl)-N-methylpyrrolidinium (Abbreviated Below as “ProMe.TFSI”)

Aside from using 81 mL of pyrrolidine instead of diethylamine and setting the reaction temperature in the autoclave at 90° C., the title ionic liquid was synthesized in the same way as in Synthesis Example 1.

### Synthesis Example 4

[Examples of the Synthesis of Polymer Layer-Bearing Inorganic Particles]

3-Methacryloxypropyltrimethoxysilane (a silane coupling agent produced by Chisso Corporation) having reactive double bonds was coupled to and coated onto Mg(OH)₂ having an average particle size of 700 nm (Kisuma 5Q, surface untreated Mg(OH)₂ produced by Kyowa Chemical Industry Co., Ltd.) by means of a dehydration reaction (Reference Document: Kappuringu-zai saiteki riyo gijutsu [Techniques for the optimal use of coupling agents], published by Kagaku Gijutsu Sogo Kenkyujo).

Next, 6.0 g of the silane coupled Mg(OH)₂ was thoroughly dispersed in 18.0 g of the DEME.TFSI obtained in Synthesis Example 1 within a 50 mL round-bottomed flask. Then, 0.15 g of azobisisobutyronitrile (abbreviated below as “AIBN”; Kanto Chemical) and 6.0 g of styrene (Kanto Chemical) were added, and the mixture was heated at 70° C. for about one hour and a half to effect the reaction.

Following reaction completion, to remove unreacted monomer and ungrafted polymer, the Mg(OH)₂ particles were washed with tetrahydrofuran (abbreviated below as “THF”; Wako Pure Chemical Industries) and suction filtered four times. After washing, the infrared spectrum of the particles was measured with an FT-IR8900 spectrometer (Shimadzu Corporation), whereupon absorption attributable to benzene rings was observed near 700 cm⁻¹, confirming that the particles had been polystyrene grafted.

The average particle size indicated above is a value that was measured using a particle size analyzer (MICROTRACHRA9320-X100, manufactured by Nikkiso Co., Ltd.).

### Synthesis Example 5

Aside from changing the polymerization time to 0.5 hour, polymer grafted Mg(OH)₂ was prepared in the same way as in Synthesis Example 4. Following reaction completion, grafting of the styrene was confirmed in the same way as in Synthesis Example 4.

### Synthesis Example 6

Aside from changing the polymerization solvent to the common organic solvent THF, polymer grafted Mg(OH)₂ was prepared in the same way as in Synthesis Example 4. Following reaction completion, grafting of the styrene was confirmed in the same way as in Synthesis Example 4.

### Synthesis Example 7

Aside from changing the polymerization solvent to the DEME.BF₄ prepared in Synthesis Example 2, polymer grafted Mg(OH)₂ was prepared in the same way as in Synthesis Example 4. Following reaction completion, grafting of the styrene was confirmed in the same way as in Synthesis Example 4.

### Synthesis Example 8

Aside from changing the polymerization solvent to the ProMe.TFSI prepared in Synthesis Example 3, polymer grafted Mg(OH)₂ was prepared in the same way as in Synthesis Example 4. Following reaction completion, grafting of the styrene was confirmed in the same way as in Synthesis Example 4.

### Synthesis Example 9

Aside from changing the polymerization solvent to ethylmethylimidazolium tetrafluoroborate (abbreviated below as “EMI.BF4”; available from Tokyo Kasei Kogyo Co., Ltd.), polymer grafted Mg(OH)₂ was prepared in the same way as in Synthesis Example 4. Following reaction completion, grafting of the styrene was confirmed in the same way as in Synthesis Example 4.

### Synthesis Example 10

Aside from changing the polymerization solvent to butylmethylimidazolium hexafluorophosphate (abbreviated below as “BMI.PF₆”; available from Kanto Chemical), polymer grafted Mg(OH)₂ was prepared in the same way as in Synthesis Example 4. Following reaction completion, grafting of the styrene was confirmed in the same way as in Synthesis Example 4.

The method described below was used to cleave the ester groups linking the grafted polymer to the Mg(OH)₂ in the polymer grafted Mg(OH)₂ particles obtained in Synthesis Examples 4 to 10, and the molecular weight and molecular weight distribution of the grafted polymer were measured.

The grafted Mg(OH)₂ particles obtained in these respective synthesis examples were dispersed in a mixed solution composed of 2 ml of distilled water, 12 ml of THF and 5 ml of ethanol (Kanto Chemical) within a 100 ml beaker, after which 0.22 g of potassium hydroxide (Sigma-Aldrich Japan) was added and the reaction was carried out at 55° C. for 7 hours.

Following the reaction, the reaction mixture was neutralized with concentrated hydrochloric acid (Wako Pure Chemical Industries, Ltd.), and the Mg(OH)₂ particles were removed. The solution remaining after removal of the particles was then concentrated, and the solid matter (grafted polymer) thus obtained was washed with water and hexane (Wako Pure Chemical Industries).

The molecular weight of the washed grafted polymer was measured by gel filtration chromatography (GPC) using the following apparatus and conditions. The results of the number-average molecular weight (Mn) and weight-average molecular weight (Mw) measurements are shown in Table 1.

Molecular Weight Measurement Conditions

GPC apparatus: C-R7A, manufactured by Shimadzu Corporation
Detector: UV spectrophotometer detector (SPD-6A), manufactured by Shimadzu Corporation
Pump: Molecular weight distribution measurement system pump (LC-6AD), manufactured by Shimadzu Corporation
Columns: A total of three columns connected in series; two Shodex KF804L (Showa Denko K.K.) columns and one Shodex KF806 (Showa Denko)
Solvent: Tetrahydrofuran
Measurement temperature: 40° C.

The thickness of the grafted polymer layer on the surface of the Mg(OH)₂ particles obtained in Synthesis Examples 4 to 10 was determined in the manner described below. The thickness of the organic layer on the Mg(OH)₂ particles (Kisuma 5A, produced by Kyowa Chemical Industry Co., Ltd.) surface treated with an organic material that are used in the subsequently described examples of the invention was also determined. Those results as well are shown in Table 1.

[Method of Measuring Thickness of Polymer Layer]

The densities of the respective Mg(OH)₂ particles obtained in Synthesis Examples 4 to 10 were determined using a gas pycnometer (Accupyc 1330, manufactured by Shimadzu Corporation; in helium). Based on these results and the density of the Mg(OH)₂ prior to grafting, the volume of the polymer layer, the volume of the inorganic hydroxide and the total surface area per cubic centimeter (cm³) of the polymer grafted inorganic hydroxide were determined. The thickness of the polymer layer was calculated from these values. The volume and total surface area were determined by assuming the Mg(OH)₂ at this time to be truly spherical.

TABLE 1

| | Mn | Mw | Thickness (nm) |
|---|---|---|---|
| Synthesis Example 4 | 690,000 | 1,760,000 | 16 |
| Synthesis Example 5 | 50,000 | 110,000 | 8.2 |
| Synthesis Example 6 | 2,000 | 5,500 | 1.5 |
| Synthesis Example 7 | 830,000 | 2,050,000 | 18 |
| Synthesis Example 8 | 580,000 | 1,550,000 | 14 |
| Synthesis Example 9 | 420,000 | 1,300,000 | 12 |
| Synthesis Example 10 | 720,000 | 1,900,000 | 17 |
| Kisuma 5A | — | — | 0* |

Note:
In Table 1, “0*” signifies that, based on calculations, the thickness is substantially 0 nm.

### Examples 1 to 6, and Comparative Examples 1 to 3

1] Preparation of Inorganic-Organic Composite Functional Compositions (Shaped Articles)

In the respective examples, a dispersion prepared by dispersing 4.75 g of the Mg(OH)₂ particles that were polymer grafted in Synthesis Example 4 (Example 1), 4.66 g of the Mg(OH)₂ particles that were polymer grafted in Synthesis Example 5 (Example 2), 4.55 g of the Mg(OH)₂ particles that were polymer grafted in Synthesis Example 6 (Comparative Example 3), 4.80 g of the Mg(OH)₂ particles that were polymer grafted in Synthesis Example 7 (Example 3), 4.70 g of the Mg(OH)₂ particles that were polymer grafted in Synthesis Example 8 (Example 4), 4.68 g of the Mg(OH)₂ particles that were polymer grafted in Synthesis Example 9 (Example 5), 4.78 g of the Mg(OH)₂ particles that were polymer grafted in Synthesis Example 10 (Example 6), 4.50 g of commercial surface-treated Mg(OH)₂ (Kisuma 5A, produced by Kyowa Chemical Industry) (Comparative Example 1), or 4.50 g of commercial untreated Mg(OH)₂ (Kisuma 5Q, produced by Kyowa Chemical Industry) (Comparative Example 2) in 4 g of THF was added to a mixture composed of 3.60 g of epoxy resin (Epiclon N-740, produced by Dainippon Ink & Chemicals, Inc.) and 0.90 g of a curing agent (Novacure HX3722, produced by Asahi Kasei Corporation), thereby giving an inorganic-organic composite functional composition.

Here, the amounts of Mg(OH)₂ added in the respective examples of the invention and comparative examples were set, using the method of calculation indicated below, so as to be equivalent on the basis of the virgin Mg(OH)₂ included in each composition.

Method of Calculation

The densities of 5 g of, respectively, the polymer grafted Mg(OH)₂, Kisuma 5A, and Kisuma 5Q were measured with a gas pycnometer (Accupyc 1330, manufactured by Shimadzu Corporation; in helium). The results were 2.39 g/cm³ for both Kisuma 5A and Kisuma 5Q, and 2.35 g/cm³ for the polymer-grafted Mg(OH)₂ prepared in Synthesis Example 4.

Here, because styrene has a density of 1.07 g/cm³ and untreated Mg(OH)₂ (Kisuma 5Q) has a density of 2.39 g/cm³, letting the polystyrene grafted volume per cubic centimeter be X cm³, we get the following:
1.07X+2.39(1−X)=2.25.
Thus, X is 0.11 cm³.

Therefore, the weight of grafted polystyrene per cubic centimeter is 0.11 cm³×1.07 g/cm³=0.12 g, and the weight of the virgin Mg(OH)₂ is (1−0.11) cm³×2.39 g/cm³=2.13 g.

Hence, the amount of grafted polymer on the above polymer-grafted Mg(OH)₂ as a proportion of the total is given by
100×0.12 g/2.13 g=5.6 wt %.

From the above, the amounts of Mg(OH)₂ present in 4.50 g of Kisuma 5A, in 4.50 g of Kisuma 5Q, and in 4.75 g of the polymer grafted Mg(OH)₂ prepared in Synthesis Example 4 are equivalent.

The amounts of grafted polymer on the polymer-grafted Mg(OH)₂ particles obtained in Synthesis Examples 5 to 10 were also calculated in the same way, and the respective amounts of addition were determined.

The inorganic-organic composite functional compositions prepared in each of the above examples of the invention and comparative examples were formed into films by bar coating. The resulting films were dried overnight, then cured by 1 hour of heat treatment at 100° C. followed by 0.5 hour of heat treatment at 150° C. The following properties of the resulting cured film were evaluated. The results are shown in Tables 2 and 3. The cured films all had a thickness of about 150 μm.

(1) Evaluation of Formability

Aside from setting the dimensions of the test specimens to a length of 10 cm, a width of 5 cm, and a thickness of about 150 μm, the cured film was evaluated based on the following criteria in accordance with the method described in JIS K 7104.
Good: The Mg(OH) ₂ was very uniformly loaded, and the cured film had a smooth surface (as determined by touch and sight).
Fair: The Mg(OH)₂ was uniformly loaded, but the surface of the cured film was uneven in places.
NG: The Mg(OH)₂ was not uniformly loaded, and the entire surface of the cured film was uneven.
   (2) Evaluation of Mechanical Strength

The elastic modulus of the cured film was measured at room temperature using a thermal diffraction/rheology system (EXTAR600; Seiko Instrument).
Exc: The elastic modulus improved substantially over that in Comparative Example 2.
Good: The elastic modulus improved over that in Comparative Example 2.
Fair: The elastic modulus improved slightly over that in Comparative Example 2.
   (3) Evaluation of Dielectric Constant

The dielectric constant of the cured film was measured at room temperature and a frequency of 1 GHz using a dielectric constant measuring instrument (4291B Impedance Material Analyzer, manufactured by Agilent Technologies). The untreated Mg(OH)₂ composition had a poor formability and a variable dielectric constant. Hence, the average of the values at four places was used.
Good: The dielectric constant was significantly lower than in Comparative Example 2.
Fair: The dielectric constant was slightly lower than in Comparative Example 2.
   (4) Evaluation of Acid Resistance

A cured film having a length of 10 cm, a width of 5 cm, and a thickness of about 150 μn was immersed for 5 minutes, one hour or 3 hours in an aqueous solution containing 20 wt % of hydrogen chloride (Wako Pure Chemical Industries), washed with distilled water, then dried and the weight following immersion for the respective lengths of time were measured.

The acid resistance was evaluated by calculating the percent weight loss from the weight before acid treatment and the weight after acid treatment, and was based also on the change in color of the cured film following acid treatment.
Good: The film was acid resistant

NG: The film lacked acid resistance

TABLE 2

| | | Elastic modulus | | | Dielectric constant | | |
|---|---|---|---|---|---|---|---|
| | | Measured | Elastic | | | Dielectric | |
| | | value | modulus | | Measured | constant | |
| | Formability | (10⁹ Pa) | ratio | Rating | value | ratio | Rating |
| Example 1 | Exc | 2.2 | 1.38 | Exc | 4.39 | 0.969 | Exc |
| Example 2 | Exc | 2.0 | 1.25 | Exc | 4.45 | 0.982 | Good |
| Example 3 | Exc | 2.3 | 1.43 | Exc | 4.37 | 0.965 | Exc |
| Example 4 | Exc | 2.1 | 1.31 | Exc | 4.40 | 0.971 | Exc |
| Example 5 | Exc | 2.1 | 1.31 | Exc | 4.40 | 0.971 | Exc |
| Example 6 | Exc | 2.2 | 1.38 | Exc | 4.39 | 0.969 | Exc |
| Comparative | Fair | 1.7 | 1.06 | Fair | 4.50 | 0.993 | NG |
| Example 1 | | | | | | | |
| Comparative | NG | 1.6 | — | NG | 4.53 | — | NG |
| Example 2 | | | | | | | |
| Comparative | Fair | 1.7 | 1.06 | Fair | 4.50 | 0.993 | NG |
| Example 3 | | | | | | | |

TABLE 3

| | Acid resistance | | | | | | | | | |
|---|---|---|---|---|---|---|---|---|---|---|
| | 5 minutes | | | 1 hour | | | 3 hours | | | |
| | Percent | | Weight | Percent | | Weight | Percent | | Weight | |
| | weight | Color | loss | weight | Color | loss | weight | Color | loss | |
| | loss | change | ratio | loss | change | ratio | loss | change | ratio | Rating |
| Example 1 | 4 | substantially | 0.21 | 12 | substantially | 0.27 | 19 | slight | 0.40 | Good |
| | | unchanged | | | unchanged | | | whitening | | |
| Example 2 | 4 | substantially | 0.21 | 13 | slight | 0.29 | 20 | slight | 0.42 | Good |
| | | unchanged | | | whitening | | | whitening | | |
| Example 3 | 4 | substantially | 0.21 | 12 | substantially | 0.27 | 19 | slight | 0.40 | Good |
| | | unchanged | | | unchanged | | | whitening | | |
| Example 4 | 4 | substantially | 0.21 | 13 | substantially | 0.29 | 20 | slight | 0.40 | Good |
| | | unchanged | | | unchanged | | | whitening | | |
| Example 5 | 5 | substantially | 0.26 | 12 | substantially | 0.27 | 19 | slight | 0.40 | Good |
| | | unchanged | | | unchanged | | | whitening | | |
| Example 6 | 4 | substantially | 0.21 | 12 | substantially | 0.27 | 19 | slight | 0.40 | Good |
| | | unchanged | | | unchanged | | | whitening | | |
| Comparative | 12 | slight | 0.63 | 40 | white | 0.90 | 45 | white | 0.96 | NG |
| Example 1 | | whitening | | | color | | | color | | |
| | | | | | change | | | change | | |
| Comparative | 19 | slight | — | 44 | white | — | 47 | white | — | NG |
| Example 2 | | whitening | | | color | | | color | | |
| | | | | | change | | | change | | |
| Comparative | 10 | slight | 0.52 | 39 | white | 0.89 | 43 | white | 0.91 | NG |
| Example 3 | | whitening | | | color | | | color | | |
| | | | | | change | | | change | | |

In above Tables 2 and 3, the ratios of the various physical property values were calculated relative to the data for Comparative Example 2 (untreated Mg(OH)₂: Kisuma 5Q); that is, with the Comparative Example 2 data serving as the denominator.

It is apparent from the results in Tables 2 and 3 that the inorganic-organic composite functional compositions in the respective examples of the invention, which include the Mg(OH)₂ particles having a grafted polymer layer prepared in Synthesis Examples 4, 5 and 7 to 10, all had an excellent formability and excellent physical properties. Moreover, the results obtained in Example 1 (Synthesis Example 4) and Comparative Example 3 (Synthesis Example 6) demonstrate that a high-molecular-weight polymer layer can be formed in a shorter period of time when an ionic liquid is used than when an organic solvent is used.

These results show that the use of an ionic liquid, in addition to reducing the burden on the environment, enables even a high-molecular-weight polymer layer to efficiently form on the surface of an inorganic material in a short period of time, thus markedly enhancing the formability and physical properties of compositions (shaped articles) obtained by adding such an inorganic material to an organic resin. It is anticipated that, owing to their excellent physical properties, the inorganic-organic composite functional compositions of the invention will see use in a variety of applications.

1. An inorganic-organic composite functional composition comprising an organic layer-bearing inorganic material and an organic resin, which is characterized in that the organic layer is formed in an ionic liquid-containing solvent.

2. The inorganic-organic composite functional composition of claim 1 which is characterized in that the organic layer is a polymer layer.

3. The inorganic-organic composite functional composition of claim 1 or 2 which is characterized in that the polymer layer is a layer formed by graft polymerization.

4. The inorganic-organic composite functional composition of claim 1 or 2 which is characterized in that the polymer layer has an average thickness of at least 5 nm.

5. The inorganic-organic composite functional composition of claim 1 or 2 which is characterized in that the inorganic material is in the form of particles having an average particle size of 1 nm to 100 μm.

6. The inorganic-organic composite functional composition of claim 1 or 2 which is characterized in that the inorganic material is one or more selected from the group consisting of alkaline earth metal carbonates, alkaline earth metal silicates, alkaline earth metal phosphates, alkaline earth metal sulfates, metal oxides, metal hydroxides, metal silicates and metal carbonates.
